(19) United States
(12) Patent Application Publication
(10) Pub. No.: US 2013/0040083 A1
(43) Pub. Date: Feb. 14, 2013

(54) METHOD FOR MANUFACTURING MAGNESIUM-ALUMINUM ALLOY CASING

(71) Applicant: Chih-Hsien Yang, Taipei City (TW)

(72) Inventor: Chih-Hsien Yang, Taipei City (TW)

(73) Assignee: Getac Technology Corporation, Hsinchu (TW)

(21) Appl. No.: 13/569,084

(22) Filed: Aug. 7, 2012

Related U.S. Application Data
(60) Provisional application No. 61/522,163, filed on Aug. 10, 2011.

(30) Foreign Application Priority Data
Dec. 6, 2011 (CN) CN201110400238.X

(51) Int. Cl. B32B 3/00; B05D 1/36; B05D 5/02

(52) U.S. Cl. 428/34.7; 427/261; 427/265

(57) ABSTRACT

A method for manufacturing magnesium-aluminum alloy casing includes performing an adhesion process to form a protective layer on an antioxidant layer which is on a magnesium-aluminum alloy substrate by a ceramic paint. The ceramic paint includes a ceramic powder, a resin, a dilution agent and a particle. The particle is one percent to fifteen percent of the ceramic paint, and the particle is used to enhance roughness of the protective layer. By performing the adhesion process to form the protective layer, effects of anti-corrosion and anti-salt fog of the magnesium-aluminum alloy casing are achieved.

### BACKGROUND

1. Technical Field

The present disclosure relates to a method for manufacturing magnesium-aluminum alloy casing, and more particularly to a method for manufacturing magnesium-aluminum alloy casing with an anti-corrosion protective layer.

2. Related Art

In recent years, in order to satisfy demands for lightweight and portability from consumers, designs of portable electronic products are developed toward being light, thin, short and small. Therefore, manufacturers develop the portable electronic products from all aspects to make structures of the electronic products become thinner without affecting original functions, efficiencies and effects. Hence, the electronic products have characteristics of lightweight and easy portability.

In terms of casing structure design of the portable electronic products, the main materials are plastic and light metal, and both of them can be used as structure and support for inner electronic components of the portable electronic products. As for the plastic, the plastic has advantages of providing better formability and cheaper cost. In comparison with the plastic, the light metal has advantages of providing rigidity, strength, anti-electromagnetic radiation and heat dissipation. In order to make the portable electronic products have the characteristics of being light, thin, short and small, the light metal is generally taken as the material of the casing. Because the light metal has good rigidity, the rigidity of the structure can be maintained when the electronic products are more lightweight and thinner. Moreover, the casing made of the light metal can have better outer appearance and heat dissipation ability.

In prior art, due to easy processing, aluminum alloy is the first light metal chosen as the casing of the electronic products, i.e. digital camera and laptop. Later, due to increasing demands for heat dissipation, electromagnetic radiation noise interference, weight and recycling of the casing, more matters are under consideration for the choice of the casing material.

Later in the prior art, the density of magnesium-aluminum alloy is two-third of that of the aluminum alloy and one-fourth of that of the steel material. The density of the magnesium-aluminum alloy is lower, but support, strength and rigidity of the magnesium-aluminum alloy are approximately the same as those of the aluminum alloy and the steel alloy. The magnesium-aluminum alloy has a good casting ability, so it can be molded by casting in all kinds of ways. In comparison with the aluminum alloy, the magnesium-aluminum alloy has lower modulus of elasticity. That is, under the same condition of being compressed, the magnesium-aluminum alloy can absorb more deformation forces. Moreover, the magnesium-aluminum alloy has a characteristic of noise reduction and can bear larger impact and shock. Further, the magnesium-aluminum alloy has a good electromagnetic shielding performance to prevent electromagnetic interference. From the above-mentioned advantages and in comparison with the aluminum alloy, the magnesium-aluminum alloy is much more suitable to be chosen as the casing of the lightweight and thin portable electronic product.

Because the magnesium-aluminum alloy has characteristics of lightweight, high strength, high compression resistance, anti-electromagnetic radiation interference, good heat dissipation and easy casting, it has been commonly used in many applications instead of plastic and aluminum alloy. Further, the latest amendment to the environmental protection regulations in the developed countries is about reducing output of waste electronics and electrical equipment (WEEE) and establishing a recycling system to raise statutory recovery. Therefore, the magnesium-aluminum alloy having the characteristics of lightweight and recyclable may become main material of the electronic products. Also, international enterprises begin to take the magnesium-aluminum alloy as the main material of the electronic products.

Actually, in prior art, during high temperature casting process of the magnesium-aluminum alloy casing, because of high molecular activity of magnesium, pin-holes may be generated on the surface of the casing. The fewer pin-holes on the partial surface of the magnesium-aluminum alloy casing are, the higher strength of the partial surface casing is. In other words, if there are more pin-holes on the partial surface of the magnesium-aluminum alloy casing, the strength of the partial surface is weaker, thereby, causing a problem of uneven surface strength. Therefore, the manufacturing yield of the magnesium-aluminum alloy casing is low when the casings are in mass production. Further, in comparison to the aluminum alloy casing, there are more pin-holes on the surface of the magnesium-aluminum alloy casing. Multiple putty and grinding processes are required to be performed for making the surface of the magnesium-aluminum alloy casing evenly and smoothly, so a large number of human resources and times is required to perform manufacturing casing process, thereby, causing high production costs.

Except meeting the demands for lightweight and easy portability, the portable electronic products are often required to be used in outdoor, and even in a strictly special environment. For example, the products needs to be used in a humid and warm tropical climate, or in an extremely cold/hot and humid environment where meets military standard. Moreover, because of the high molecular activity of magnesium, the magnesium-aluminum alloy casing in the prior art can easily be rusted and corroded with salty moisture (as known as salt fogs). Therefore, multiple chemical conversion treatments and coating processes are required to be performed in order to prevent the magnesium-aluminum alloy casing from being oxidized and corroded by exposing salt fogs. Specifically, during the coating process of the magnesium-aluminum alloy casing, a chemical conversion layer is coated in advance for preventing from being rusted and corroded. But the coating of the chemical conversion layer may not be distributed evenly, other coating processes of each two layers of bottom paints and surface paints are required further for leveling the surface. Therefore, at least five anti-corrosion coating processes are required to be performed, so the manufacturing costs are increased.

To sum up, while taking the magnesium-aluminum alloy as the casing material of the electronic products, due to the characteristics of the material, at least five layers of anti-corrosion are required to be coated and the casing may prevent form being oxidized by exposing to the salt fogs, thereby, causing time-consuming and high-manufacturing-cost problems.

### SUMMARY

Accordingly, the present disclosure relates to a method for manufacturing magnesium-aluminum alloy casing, and more particularly to a method for manufacturing magnesium-aluminum alloy casing with an anti-corrosion protective layer, thereby overcoming the deficiencies existing in the prior art that the multiple anti-corrosion adhesion process are needed to be performed such that time-consuming problem and high production costs are generated.

The disclosure discloses a method for manufacturing magnesium-aluminum alloy casing. The method includes performing an adhesion process to form a protective layer on an antioxidant layer which is on a magnesium-aluminum alloy substrate by a ceramic paint. The ceramic paint includes a ceramic powder, a resin, a dilution agent and a particle. The particle is one percent to fifteen percent of the ceramic paint, and the particle is used to enhance roughness of the protective layer.

The disclosure discloses a magnesium-aluminum alloy casing, and the magnesium-aluminum alloy casing includes a magnesium-aluminum alloy substrate, an antioxidant layer and a protective layer. The antioxidant layer is disposed on the surface of the magnesium-aluminum alloy substrate and is used to prevent the magnesium-aluminum alloy from being oxidized. The protective layer is disposed on the antioxidant layer, and the protective layer is adhered on the antioxidant layer by a ceramic paint. The ceramic paint includes a ceramic powder, a resin, a dilution agent and a particle, the particle is one percent to fifteen percent of the ceramic paint, and the particle is used to enhance roughness of the protective layer.

The above-mentioned method for manufacturing magnesium-aluminum alloy casing according to the disclosure, by adhering the ceramic paint to form the protective layer on the antioxidant layer of the magnesium-aluminum alloy casing, the time-consuming and high production cost problems resulting from the material characteristic of the magnesium-aluminum alloy are solved. Besides, at least five times of needed anti-corrosion adhesion processes are improved, and an effect of anti-salt-fog-corrosion magnesium-aluminum alloy casing is achieved. Moreover, a laptop with the magnesium-aluminum alloy casing meets the military standard MIL-STD 810, Method. 509 (that is, a salt spray mist test). At last, the method may improve manufacturing efficiency and lower production costs, and the protection layer has effects of surface protection and anti-salt-fog-corrosion.

### BRIEF DESCRIPTION OF THE DRAWINGS

The disclosure will become more fully understood from the detailed description given herein below for illustration only, and thus are not limitative of the disclosure, and wherein:

FIG. 1 is a structural view of a magnesium-aluminum alloy casing according to an embodiment;

FIG. 2 is a flow chart of a method for manufacturing magnesium-aluminum alloy casing according to an embodiment;

FIG. 3 is a structural view of a magnesium-aluminum alloy casing with a protective layer according to another embodiment;

FIG. 4 is a structural view of a magnesium-aluminum alloy casing with a protective layer according to yet another embodiment; and

FIG. 5 is a flow chart of a method for manufacturing magnesium-aluminum alloy casing according to another embodiment.

### DETAILED DESCRIPTION

The detailed features and advantages of the disclosure are described below in great detail through the following embodiments, the content of the detailed description is sufficient for those skilled in the art to understand the technical content of the present disclosure and to implement the disclosure there accordingly. Based upon the content of the specification, the claims, and the drawings, those skilled in the art can easily understand the relevant objectives and advantages of the disclosure.

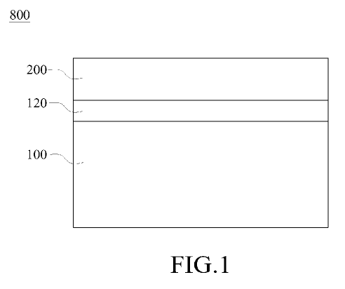

The following describes a magnesium-aluminum alloy casing according to an embodiment of the disclosure. FIG. 1 is a structural view of a magnesium-aluminum alloy casing according to an embodiment. Referring to FIG. 1, this embodiment discloses a magnesium-aluminum alloy casing 800.

In this embodiment, the magnesium-aluminum alloy casing 800 comprises a magnesium-aluminum alloy substrate 100, an antioxidant layer 120 and a protective layer 200. The magnesium-aluminum alloy substrate 100 is the main structure of the magnesium-aluminum alloy casing 800. The antioxidant layer 120 is disposed on the magnesium-aluminum alloy substrate 100 for preventing the magnesium-aluminum alloy substrate 100 from being oxidized by ambient air. The protective layer 200 is disposed on the antioxidant layer 120. The protective layer 200 formed by a ceramic paint is adhered on the antioxidant layer 120. The thickness of the protective layer 200 is more than or equal to 20 micrometers (μm).

In this embodiment, the antioxidant layer 120 forms a uniform and dense antioxidant film on the magnesium-aluminum alloy substrate 100 by an acid soluble calcium. The film is used to prevent the magnesium-aluminum alloy substrate 100 from exposure and performing oxidation reactions.

It should be noted that in this embodiment, the ingredients of the ceramic paint comprise a ceramic powder, a resin, a dilution agent and a particle. The particle is one percent to fifteen percent of the ceramic paint, and the particle is used to enhance roughness of the protective layer. In this embodiment, the resin is epoxy resin.

Moreover, in this embodiment, the material of the ceramic powder is one or a combination of aluminum oxide, silicon oxide, zinc oxide, boron nitride, magnesium oxide, cerium oxide, silicon carbide, zirconium oxide, diamond powder and magnetic iron oxide.

In one embodiment, the dilution agent is methyl ether, but is not limited to the disclosure. In other embodiments, the dilution agent is dipropylene glycol methyl ether (DPM).

In this embodiment, the material of the particle is one or a combination of powder bead, silica flour, textured powder and silver plasma.

Magnesium-aluminum alloy and aluminum alloy are commonly used materials of electronic device casing, but the material properties of the magnesium-aluminum alloy and those of the aluminum alloy are extremely different. As for the magnesium-aluminum alloy, the density of the magnesium-aluminum alloy is lower and pin-holes are easily generated while forming the magnesium-aluminum alloy casing. Therefore, a putty process is required to be performed to improve the rough surface of the casing. Furthermore, because of high molecular activity of magnesium, a bottom paints coating and chemical conversion processes are required to be performed to form an antioxidant thin film, so that the processes prevent the surface of the magnesium-aluminum alloy casing from being oxidized with outside salt fogs, thereby, corroding the surface and destroying structure rigidity of the casing.

In this embodiment, a type number of the magnesium-aluminum alloy is AZ-91D, but is not limited to the disclosure.

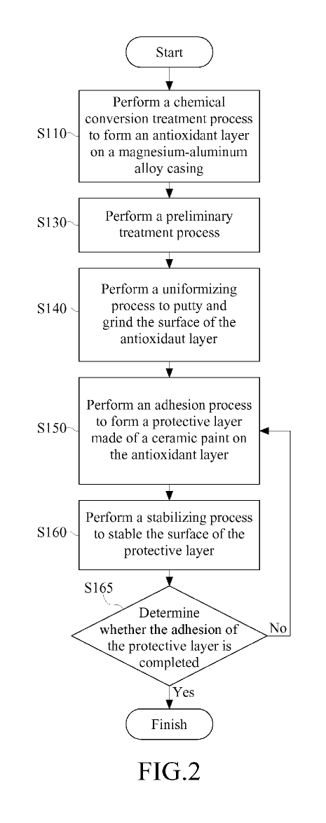

The following describes a method for manufacturing magnesium-aluminum alloy casing according to an embodiment of the disclosure. Please refer to FIGS. 1 and 2, FIG. 2 is a flow chart of a method for manufacturing magnesium-aluminum alloy casing according to an embodiment.

At first, a magnesium-aluminum alloy substrate 100 is performed with a chemical conversion process to form an antioxidant layer 120 on the magnesium-aluminum alloy substrate 100 (Steps 110). To simplify, the chemical conversion process including a rinsing, a degreasing, an acid cleaning (pickling), a surface adjusting, a chemical conversion adhesion and a baking procedure forms the antioxidant layer 120 on the magnesium-aluminum alloy substrate 100 to prevent from being oxidized with the salt fogs.

Then, a preliminary treatment process is performed (Steps 130). Specifically, an incoming quality control procedure is performed to eliminate the magnesium-aluminum alloy substrates 100 with deformation, broken column, incompletely filled part, crack or mixing wrong material after the above-mentioned chemical conversion process. The qualified magnesium-aluminum alloy substrate 100 is transited to next working stop. Then, a conductive shielding and covering process is performed to cover certain areas (not shown) on the surface of the magnesium-aluminum alloy substrate 100 where are not required to be adhered by a protective layer 200 with a shield or a cover.

After that, a uniformizing process is performed to putty and grind a bump or a depression on the surface of the antioxidant layer 120 (Step 140). The above-mentioned putty procedure is performed to putty a larger crack on the magnesium-aluminum alloy substrate 100 by a two-part epoxy. Then, the magnesium-aluminum alloy substrate 100 is baked at 150° C. about 25 minutes. Next, the above-mentioned grind procedure is performed to grind the puttied part. In this embodiment, the grind procedure includes a hard grinding operation and a light grinding operation. The hard grinding operation is performed first to even the puttied area on the surface of the antioxidant layer 120 by a hard grinding machine. Then, the light grinding operation is performed to sand a part of the surface with residual, burr (flash) and step (gape) where the hard grinding operation may not grind with a piece of emerypaper. After finishing the above-mentioned processes, the dust generated by the grind procedure is washed out. The magnesium-aluminum alloy substrate 100 is soaked in a repair solution to repair the surface of the antioxidant layer 120. The soaking time is about 3 minutes. After cleaning the repair solution out and draining water off on the surface of the antioxidant layer 120, the magnesium-aluminum alloy substrate 100 is baked at 150° C. about 25 to 30 minutes. The baking temperature and baking time depend on actual environment and requirement.

Afterwards, an adhesion process is performed to form the protective layer 200 made of a ceramic paint on the antioxidant layer 120 of the magnesium-aluminum alloy substrate 100 (Step 150). The adhesion process is used to form the protective layer 200 on the antioxidant layer 120. The protective layer 200 is made of the ceramic paint, and the thickness of the protective layer 200 is more than or equal to 20 μm. Specifically, in this embodiment, the protective layer 200 is painted by a sprayer (in a manual or an automatic manner). The distance between the sprayer and the magnesium-aluminum alloy substrate 100 is about 15 to 20 centimeters (cm). A painting width is about 15 to 20 cm, but the above-mentioned adhesion process is not limited to this embodiment. In other embodiments, the protective layer 200 may be adhered by coating or soaking. Simultaneously, in other embodiment, an automatic sprayer may be used to paint. The painting way and tools may be adjusted according to the property and characteristic of the magnesium-aluminum alloy substrate 100.

It should be noted that, the ingredients of the ceramic paint comprise a ceramic powder, a resin, a dilution agent and a particle. The particle is one percent to fifteen percent of the ceramic paint, and the particle is used to enhance roughness of the protective layer. The material of the ceramic powder is one or a combination of aluminum oxide, silicon oxide, zinc oxide, boron nitride, magnesium oxide, cerium oxide, silicon carbide, zirconium oxide, diamond powder and magnetic iron oxide. In this embodiment, the resin is epoxy resin.

In one embodiment, the dilution agent is methyl ether, but is not limited to the disclosure. In other embodiments, the dilution agent is DPM.

In this embodiment, the ingredients of the ceramic paint comprise a hardening agent and a gloss agent. The proportion of the hardening agent is lower than eight percent of the ceramic paint. The ratio of the resin to the hardening agent is four to one.

In this embodiment, the gloss agent is silicon oil, but is not limited to the disclosure. In another embodiment, the gloss agent may be a hydrophobic and oleophobic agent.

In this embodiment, a material of the particle is one or a combination of powder bead, silica flour, textured powder and silver plasma.

After that, a stabilizing process is performed to stabilize the surface of the protective layer 200 (Step 160). In this embodiment, the magnesium-aluminum alloy substrate 100 is baked at 150° C. about 25 to 30 minutes, but is not limited to the disclosure. In another embodiment, the protective layer 200 may be dried by itself at room temperature and get into a stable state. The stable state means that a constant state of the surface of the protective layer 200.

Determine whether the adhesion of the protective layer 200 is completed (Step 165). That is, the Step 165 is to determine whether the protective layer 200 is evenly distributed on the antioxidant layer 120.

If the determination result indicates that the adhesion is not qualified, the Steps 150, 160 and 165 are repeated until the protective layer 200 is evenly distributed on the antioxidant layer 120. Later, the shield and the cover are removed and burrs are grinded, so that the manufacturing of the magnesium-aluminum alloy casing 800 is completed.

In one embodiment, after the Step 165, if the adhesion is not qualified, a face repair process is performed to manually sand the defects such as bitty appearance, excess paint and burr with a piece of emerypaper. Then, the Step 150 is repeated.

According to an embodiment of the disclosure, compare an adhesion manufacturing process of the ceramic paint with that of a commonly used paint, there are extremely different between them. As for the ceramic paint, the coating speed of the coating process is slower, but viscosity and hardness of the ceramic paint are higher. While testing, the hardness of the ceramic paint is more than 4H and that of the commonly used paint is 2H. Furthermore, the protective layer 200 formed by the ceramic paint has effects of anti-salt fog and anti-corrosion.

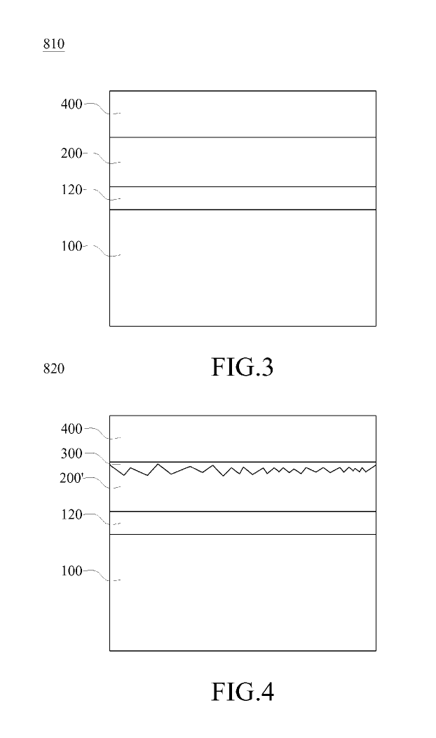

The following describes a structure of magnesium-aluminum alloy casing according to another embodiment of the disclosure. Please refer to FIG. 3, FIG. 3 is a structural view of a magnesium-aluminum alloy casing according to another embodiment. The structure of FIG. 3 is similar to that of FIG. 1, so the element symbols in FIG. 3 which correspond to those in FIG. 1 are with the same function or structure.

The magnesium-aluminum alloy casing 810 comprises a magnesium-aluminum alloy substrate 100, an antioxidant layer 120, a first protective layer 200 and a second protective layer 400. The magnesium-aluminum alloy substrate 100 is the main structure of the magnesium-aluminum alloy casing 810. The antioxidant layer 120 is disposed on the magnesium-aluminum alloy substrate 100 for preventing the magnesium-aluminum alloy substrate 100 from being oxidized by ambient air. The first protective layer 200 is disposed on the antioxidant layer 120. The first protective layer 200 formed by a ceramic paint is adhered on the antioxidant layer 120. The second protective layer 400 is disposed on the first protective layer 200. The second protective layer 400 formed by the ceramic paint is adhered on the first protective layer 200. The second protective layer 400 is used to prevent the magnesium-aluminum alloy substrate 100 from exposure and being oxidized by salt fogs.

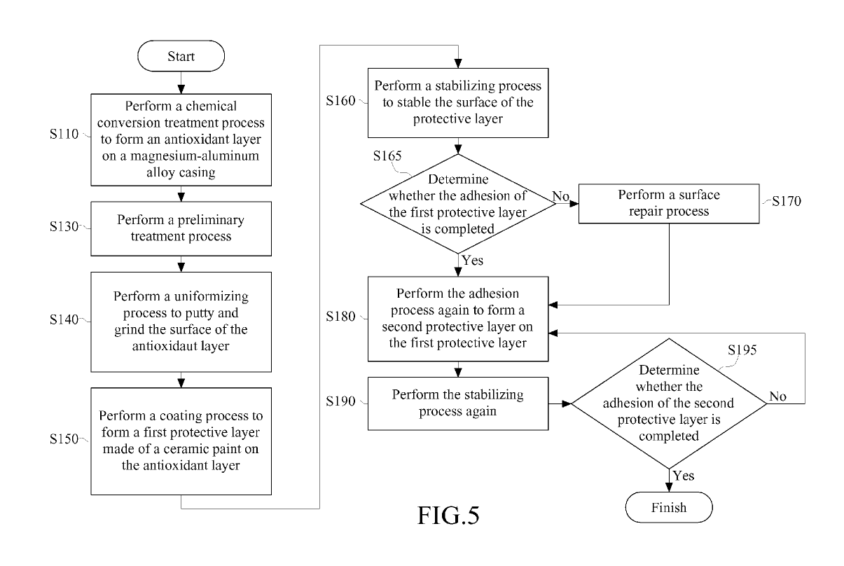

The following describes a structure of magnesium-aluminum alloy casing according to yet another embodiment of the disclosure. Please refer to FIG. 4, FIG. 4 is a structural view of a magnesium-aluminum alloy casing according to yet another embodiment. The structure of FIG. 4 is similar to that of FIG. 3, so the element symbols in FIG. 4 which correspond to those in FIG. 1 are with the same function or structure.

Compared with the structure in FIG. 3, the magnesium-aluminum alloy casing 810 of FIG. 4 further comprises a putty layer 300 disposed on the first protective layer 200′ of the magnesium-aluminum alloy casing 820. Because when the first protective layer 200′ is not adhered evenly, the putty layer 300 is further added to even the surface of the first protective layer 200′. Then, a second protective layer 400 is disposed on the putty layer 300. The second protective layer 400 is used to prevent the magnesium-aluminum alloy substrate 100 from exposure and being corroded by the salt fogs.

The following describes a method of magnesium-aluminum alloy casing according to another embodiment of the disclosure. Please refer to FIGS. 3, 4 and 5, FIG. 5 is a flow chart of a method for manufacturing magnesium-aluminum alloy casing according to another embodiment.

At first, a chemical conversion process is performed to form an antioxidant layer 120 on the magnesium-aluminum alloy substrate 100 (Steps 110). Then, a preliminary treatment process is performed (Steps 130). After that, a uniformizing process is performed to putty and grind a bump or a depression on the surface of the antioxidant layer 120 (Step 140). After the uniformizing process is finished, an adhesion process is performed to form a first protective layer 200 made of a ceramic paint on the antioxidant layer 120 of the magnesium-aluminum alloy substrate 100 (Step 150). Then, a stabilizing process is performed to stabilize the surface of the first protective layer 200 (Step 160). Later, determine whether the adhesion of the first protective layer 200 is completed (Step 165).

Please refer to FIGS. 4 and 5. In this embodiment, after the Step 165, if the determination result indicates that the adhesion is not qualified, a surface repair process is performed (Step 170), the face repair process is to manually sand the defects on the first protective layer 200′ such as bitty appearance, excess paint and burr with a piece of emerypaper. Then, a putty layer 300 is disposed on the first protective layer 200′.

Please refer to FIGS. 3 and 5. After the Step 170 is finished or the determination indicates that the adhesion is completed in the Step 165, another adhesion process is performed again to form a second protective layer 400 on the first protective layer 200 (Step 180).

In another embodiment, please refer to FIGS. 4 and 5. After the Step 170 is finished or the determination indicates that the adhesion is completed in the Step 165, another adhesion process is performed again to form a second protective layer 400 (Step 180). Here, the second protective layer 400 is on the first protective layer 200 and the putty layer 300.

Please refer to FIGS. 3 and 5. Afterwards, the stabilizing process is performed again (Step 190). Then, determine whether the adhesion of the second protective layer 400 is completed (Step 195). If the determination result indicates that the adhesion of the second protective layer 400 is not qualified, the Step 180, Step 190, Step 195 are repeated until the adhesion of the second protective layer 400 is completed. In this embodiment, the thickness of the first protective layer 200 is between 20 to 30 μm, and the total thickness of the first protective layer 200 and the second protective layer 400 is more than 35 μm.

In this embodiment, the particles comprise a powder bead with 200 to 250 mesh. The proportion of the powder beads is 4 to 8 percent of the ceramic paint. According to this embodiment, the manufacturing yields may increase to 95% to achieve the effect of the disclosure.

Further, during the manufacturing process, if a crack and defects are generated on the surface of the magnesium-aluminum alloy substrate 100, a material is required for putting and grinding on the crack. The other defects, such as small pin-holes, may be covered by the first protective layer 200. In this embodiment, the ceramic paint comprises an anti-settling agent (or anti-Precipitation agent) and a wax. The anti-settling agent is used to mix the powder beads evenly without precipitation. The proportion of the anti-settling agent is 0.5 to 2 percent of the ceramic paint. The wax is used to enhance the surface being smooth and bright. The proportion of the wax is 5 to 10 percent of the ceramic paint. The gloss is adjusted to 4 to 40 degrees. The hardening agent is H19C, but is not limited to the disclosure. In this embodiment, the viscosity of the ceramic paint is two to three times as the commonly used paint. After the adhesion, the hardness may be increased more than 5H. In this embodiment, only one kind of ceramic paints is required. In prior art, two kinds of ceramic paints (that is, one bottom paint and one surface paint) are required to perform adhesion processes twice, respectively. Compared with the prior art, only one kind of paint is needed in the disclosure, and the embodiment of the disclosure may shorten manufacturing time and save paint costs.

In summary, an embodiment of the present invention discloses a method for manufacturing magnesium-aluminum alloy casing with an anti-corrosion protective layer. In order to prevent the casing from being oxidized with outside salt fogs, the magnesium-aluminum alloy requires five anti-corrosion adhesion layers for the adhesion process. However, it causes time-consuming and incur high production costs. By adhering a ceramic paint to form a protective layer on an antioxidant layer of a magnesium-aluminum alloy substrate, the method solve the above-mentioned problems and make the magnesium-aluminum alloy casing achieve anti-corrosion. So, the magnesium-aluminum alloy casing can meet the military standard MIL-STD 810, Method. 509 (salt spray mist test). Meanwhile, manufacturing time is shortened, production cost is saved and manufacturing efficiency is enhanced. Also, the protective layer has effects of surface protection and anti-salt fog.

What is claimed is:

1. A method for manufacturing magnesium-aluminum alloy casing, comprising the step of:
performing an adhesion process to form a protective layer on an antioxidant layer which is on a magnesium-aluminum alloy substrate by a ceramic paint, wherein the ingredients of the ceramic paint comprise a ceramic powder, a resin, a dilution agent and a particle, the particle is one percent to fifteen percent of the ceramic paint, and the particle is used to enhance roughness of the protective layer.

2. The method for manufacturing magnesium-aluminum alloy casing according to claim 1, wherein a material of the ceramic powder is one or a combination of aluminum oxide, silicon oxide, zinc oxide, boron nitride, magnesium oxide, cerium oxide, silicon carbide, zirconium oxide, diamond powder and magnetic iron oxide.

3. The method for manufacturing magnesium-aluminum alloy casing according to claim 1, wherein the resin is epoxy resin.

4. The method for manufacturing magnesium-aluminum alloy casing according to claim 1, wherein the dilution agent is methyl ether.

5. The method for manufacturing magnesium-aluminum alloy casing according to claim 1, wherein the dilution agent is dipropylene glycol methyl ether (DPM).

6. The method for manufacturing magnesium-aluminum alloy casing according to claim 1, wherein the ingredients of the ceramic paint comprise a hardening agent.

7. The method for manufacturing magnesium-aluminum alloy casing according to claim 6, wherein the proportion of the hardening agent of the ceramic paint is smaller than eight percent.

8. The method for manufacturing magnesium-aluminum alloy casing according to claim 6, wherein the ratio of the resin to the hardening agent is four to one.

9. The method for manufacturing magnesium-aluminum alloy casing according to claim 1, wherein the ingredients of the ceramic paint comprise a gloss agent.

10. The method for manufacturing magnesium-aluminum alloy casing according to claim 9, wherein the gloss agent is silicon oil or a hydrophobic and oleophobic agent.

11. The method for manufacturing magnesium-aluminum alloy casing according to claim 1, wherein a material of the particle is one or a combination of powder bead, silica flour, textured powder and silver plasma.

12. The method for manufacturing magnesium-aluminum alloy casing according to claim 1, wherein the thickness of the protective layers is larger than 20 micrometers.

13. The method for manufacturing magnesium-aluminum alloy casing according to claim 1, wherein after the step of performing a adhesion process, the method for manufacturing magnesium-aluminum alloy casing comprises the steps of:
grinding the surface of the protective layer for fixing defects of the surface such as bitty appearance, excess paint or burr; and
performing another adhesion process to form another protective layer on the protective layer.

14. A magnesium-aluminum alloy casing, comprising;
a magnesium-aluminum alloy substrate;
an antioxidant layer disposed on the surface of the magnesium-aluminum alloy substrate for preventing the magnesium-aluminum alloy from being oxidized; and
a protective layer disposed on the antioxidant layer, the protective layer being adhered on the antioxidant layer by a ceramic paint, wherein the ingredients of the ceramic paint comprise a ceramic powder, a resin, a dilution agent and a particle, the particle is one percent to fifteen percent of the ceramic paint, and the particle is used to enhance roughness of the protective layer.

15. The magnesium-aluminum alloy casing according to claim 14, wherein a material of the ceramic powder is one or a combination of aluminum oxide, silicon oxide, zinc oxide, boron nitride, magnesium oxide, cerium oxide, silicon carbide, zirconium oxide, diamond powder and magnetic iron oxide.

16. The magnesium-aluminum alloy casing according to claim 14, wherein the resin is epoxy resin.

17. The magnesium-aluminum alloy casing according to claim 14, wherein the dilution agent is methyl ether.

18. The magnesium-aluminum alloy casing according to claim 14, wherein the dilution agent is dipropylene glycol methyl ether (DPM).

19. The magnesium-aluminum alloy casing according to claim 14, wherein a material of the particle is one or a combination of powder bead, silica flour, textured powder and silver plasma.

20. The magnesium-aluminum alloy casing according to claim 14, further comprising another protective layer disposed on the protective layer by the ceramic paint, for preventing the magnesium-aluminum alloy substrate from being exposed outside and being corroded by salt fogs.
